(19) United States
(12) Patent Application Publication
(10) Pub. No.: US 2025/0056387 A1
(43) Pub. Date: Feb. 13, 2025

(54) METHOD AND APPARATUS FOR EDGE COMPUTING

(71) Applicant: Telefonaktiebolaget LM Ericsson (publ), Stockholm (SE)

(72) Inventors: Fengpei ZHANG, Guangzhou (CN); Yun ZHANG, Guangzhou (CN); Boya ZHANG, Guangzhou (CN)

(21) Appl. No.: 18/719,402

(22) PCT Filed: Dec. 6, 2022
(86) PCT No.: PCT/CN2022/136767

§ 371 Date: Jun. 13, 2024

(30) Foreign Application Priority Data
Dec. 14, 2021 (WO) PCT/CN2021/137885

(51) Int. Cl. H04W 48/16; H04W 4/12; H04W 60/04

(52) U.S. Cl. CPC H04W 48/16; H04W 4/12; H04W 60/04

(57) ABSTRACT

Embodiments of the present disclosure provide method and apparatus for edge computing. A method performed by a gateway includes deciding to discover a first Edge Application Server (EAS) for a terminal device. The method further includes sending a first message including information about the first EAS to the terminal device.

### TECHNICAL FIELD

The non-limiting and exemplary embodiments of the present disclosure generally relate to the technical field of communications, and specifically to methods and apparatuses for edge computing.

### BACKGROUND

This section introduces aspects that may facilitate a better understanding of the disclosure. Accordingly, the statements of this section are to be read in this light and are not to be understood as admissions about what is in the prior art or what is not in the prior art.

Edge Computing is a concept that enables services to be hosted close to service consumers and provides benefits such as efficient service delivery with significant reduction in end-to-end latency and decreased load on a transport network. The benefits of Edge Computing will strengthen the promise of wireless network (such as fifth generation (5G) network) and expand the prospects for several new and enhanced use cases, such as virtual and augmented reality, Internet of Thing (IoT), Industrial IoT, autonomous driving, real-time multiplayer gaming etc.

In 3rd Generation Partnership Project (3GPP) Release 17, 3GPP aims to provide native support of Edge Computing in 3GPP networks. These efforts include initiatives across several working groups in 3GPP including SA6, SA2, SA3, SA4 and SA5, which cover application layer architecture, core network enhancement, security, media processing, and management aspects respectively.

3GPP TS 23.558 V17.1.0, the disclosure of which is incorporated by reference herein in its entirety, specifies application layer architecture, procedures and information flows necessary for enabling edge applications (EDGEAPP) over 3GPP networks. An objective of the work is to define an enabling layer to facilitate communication between an Application Clients (AC) running on a user equipment (UE) and an Edge Application Servers (EAS) deployed on an Edge Data Network (EDN). This includes aspects of service provisioning and EAS discovery. In addition, the work aims to provide support services such as application context transfer between EASs for service continuity, service enablement and capability exposure APIs (Application Programming Interface) towards the EAS.

Open Mobile Alliance (OMA) Lightweight M2M (LwM2M) is an IoT protocol designed for sensor networks to meet the demands of a machine to machine (M2M) environment. With LwM2M Protocol, OMA has responded to demand in the market for a common standard for managing lightweight and low power devices on a variety of networks to realize the potential of IoT. The LwM2M Protocol is designed for both remote management of IoT devices and related service enablement functions. It features a modern architectural design based on REST (Representational State Transfer) and defines an extensible resource and data model. LwM2M is built on top of an efficient secure data transfer Internet Engineering Task Force (IETF) standard called Constrained Application Protocol (CoAP). LwM2M is specified by a group of industry experts in the Open Mobile Alliance Device Management Working Group and is based on IETF protocols and security standards.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The EDGEAPP can be used by different vertical applications such as factories, smart cities, logistics. There may be constrained devices which require low battery consumption to communicate with EAS in EDN through lossy networks for example for offloading purposes (even though low latency may not be required by those use cases).

Currently, EDGEAPP is not optimized to support constrained devices. A typical limitation is that all reference points between UE and Edge Enablement Layer (EEL) (comprising Edge Configuration Server (ECS) and Edge Enabler Servers (EES)) are based on HTTP (Hypertext Transfer Protocol). For constrained devices, HTTP may be too complicated for them to save battery consumption.

LwM2M protocol is one of mainstream protocols for constrained devices. LwM2M protocol has introduced 5G support. However, currently there is no EDGEAPP support in LwM2M protocol yet.

To overcome or mitigate at least one above mentioned problems or other problems, an improved solution for edge computing may be desirable.

In a first aspect of the disclosure, there is provided a method performed by a gateway. The method comprises deciding to discover a first Edge Application Server (EAS) for a terminal device. The method further comprises sending a first message comprising information about the first EAS to the terminal device.

In an embodiment, the first message comprises at least one of a response for a registration request from the terminal device, or a write request.

In an embodiment, the method further comprises obtaining Edge Configuration Server (ECS) configuration information.

In an embodiment, the information about the first EAS comprises at least one of an identifier of the first EAS, endpoint information of the first EAS, or an identity of an application client (AC).

In an embodiment, the information about the first EAS further comprises a type of the first EAS and the type of the first EAS is set as source.

In an embodiment, the method further comprises obtaining an identifier of an Edge Enabler Client (EEC) and at least one application client (AC) profile of at least one AC in the terminal device.

In an embodiment, the method further comprises receiving a registration request comprising an identifier of an Edge Enabler Client (EEC) from the terminal device. The method further comprises sending a response for the registration request to the terminal device.

In an embodiment, the method further comprises sending a second message comprising the identifier of EEC and security credentials to an Edge Configuration Server (ECS). The method further comprises receiving a third message comprising one or more Edge Data Network (EDN) configuration information from the ECS. Each EDN configuration information comprises information about one or more Edge Enabler Servers (EES). The method further comprises selecting an EES from the one or more EES.

In an embodiment, selecting an EES from the one or more EES comprises selecting the EES from the one or more EES based on service area and/or service continuity support.

In an embodiment, the method further comprises sending an EEC registration request comprising the identifier of EEC and security credentials to the selected EES. The method further comprises receiving an EEC registration response from the selected EES.

In an embodiment, the method further comprises receiving a registration update request comprising updated registration information from the terminal device. The method further comprises sending an EEC registration update request comprising the updated registration information to the selected EES. The method further comprises receiving an EEC registration update response from the selected EES. The method further comprises sending a registration update response to the terminal device.

In an embodiment, the method further comprises sending an EAS discovery request to the selected EES. The EAS discovery request comprises the identifier of EEC and security credentials. The method further comprises receiving an EAS discovery response from the selected EES. The EAS discovery response comprises information about one or more discovered EASs. The method further comprises selecting the first EAS from the one or more discovered EASs.

In an embodiment, the EAS discovery request further comprises location information of the terminal device.

In an embodiment, selecting the first EAS from the one or more discovered EASs comprises selecting the first EAS from the discovered EASs based on at least one of service area, transport support or service continuity support.

In an embodiment, the method further comprises receiving target information notification from the selected EES. The target information notification comprises information about a second EAS. The method further comprises sending the target information notification to the terminal device.

In an embodiment, the target information notification further comprises information about a target EES.

In an embodiment, the target information notification is sent to the terminal device in a write request for writing the information about the second EAS to the terminal device.

In an embodiment, the information about the second EAS comprises at least one of an identifier of the second EAS, endpoint information of the second EAS, or an identity of an application client (AC).

In an embodiment, the information about the second EAS further comprises a type of the second EAS and the type of the second EAS is set as target.

In an embodiment, the target information notification indicates that the second EAS is not ready to serve an application client in the terminal device.

In an embodiment, the method further comprises receiving from the selected EES a second message for confirming that Application Context Relocation (ACR) has completed. The method further comprises sending to the terminal device a third message for indicating that an application client in the terminal device can switch application data communication from the first EAS to the second EAS.

In an embodiment, the third message is a write request for updating a type of the second EAS as source.

In an embodiment, the terminal device comprises at least one of a resource constrained device, an Internet of thing device, or a lightweight machine to machine (LwM2M) client.

In an embodiment, a communication between the terminal device and the gateway uses at least one of Internet of Thing (IoT) protocol, LwM2M Protocol, or Constrained Application Protocol (CoAP).

In an embodiment, a communication between an Edge Configuration Server and the gateway and/or a communication between an Edge Enabler Server and the gateway use Hypertext Transfer Protocol (HTTP).

In an embodiment, deciding to discover the first EAS for the terminal device comprises deciding to discover the first for the terminal device based on a policy.

In an embodiment, the policy comprises at least one of a change of a geographical location of the terminal device, a change of a topological location of the terminal device, a change of deployment of EAS, or a reception of a registration request from the terminal device.

In a second aspect of the disclosure, there is provided a method performed by a terminal device. The method comprises receiving a first message comprising information about a first Edge Application Server (EAS) from a gateway. The method further comprises connecting to the first EAS.

In an embodiment, the first message comprises at least one of a response for a registration request from the terminal device, or a write request.

In an embodiment, the method further comprises sending a registration request comprising an identifier of an Edge Enabler Client (EEC) to the gateway. The method further comprises receiving a response for the registration request from the gateway.

In an embodiment, the information about the first EAS comprises at least one of an identifier of the first EAS, endpoint information of the first EAS, or an identity of an application client (AC).

In an embodiment, the information about the first EAS further comprises a type of the first EAS and the type of the first EAS is set as source.

In an embodiment, the method further comprises sending a registration update request comprising updated registration information to the gateway. The method further comprises receiving a registration update response from the gateway.

In an embodiment, the method further comprises receiving target information notification from the gateway. The target information notification comprises information about a second EAS.

In an embodiment, the target information notification is received from the gateway in a write request for writing the information about the second EAS to the terminal device.

In an embodiment, the information about the second EAS comprises at least one of an identifier of the second EAS, endpoint information of the second EAS, or an identity of an application client (AC).

In an embodiment, the information about the second EAS further comprises a type of the second EAS and the type of the second EAS is set as target.

In an embodiment, the target information notification indicates that the second EAS is not ready to serve an application client in the terminal device.

In an embodiment, the method further comprises receiving from the gateway a third message for indicating that an application client in the terminal device can switch application data communication from the first EAS to the second EAS. The method further comprises switching application data communication from the first EAS to the second EAS.

In an embodiment, the third message is a write request for updating a type of the second EAS as source.

In an embodiment, the method further comprises sending a bootstrap request to a bootstrap server. The method further comprises receiving from the bootstrap server a bootstrap write request to configure the terminal device with information about the gateway.

In an embodiment, the terminal device comprises at least one of a resource constrained device, an Internet of thing device, or a lightweight machine to machine (LwM2M) client.

In an embodiment, a communication between the terminal device and the gateway and a communication between the terminal device and a bootstrap server use at least one of Internet of Thing (IoT) protocol, LwM2M Protocol, or Constrained Application Protocol (CoAP).

In a third aspect of the disclosure, there is provided a method performed by a bootstrap server. The method comprises receiving a bootstrap request from a terminal device. The method further comprises sending to the terminal device a bootstrap write request to configure the terminal device with information about the gateway.

In an embodiment, the terminal device comprises at least one of a resource constrained device, an Internet of thing device, or a lightweight machine to machine (LwM2M) client.

In an embodiment, a communication between the terminal device and the gateway and a communication between the terminal device and the bootstrap server use at least one of Internet of Thing (IoT) protocol, LwM2M Protocol, or Constrained Application Protocol (CoAP).

In a fourth aspect of the disclosure, there is provided a gateway. The gateway comprises a processor and a memory coupled to the processor. Said memory contains instructions executable by said processor. Said gateway is operative to decide to discover a first Edge Application Server (EAS) for a terminal device. Said gateway is further operative to send a first message comprising information about the first EAS to the terminal device.

In a fifth aspect of the disclosure, there is provided a terminal device. The terminal device comprises a processor and a memory coupled to the processor. Said memory contains instructions executable by said processor. Said terminal device is operative to receive a first message comprising information about a first Edge Application Server (EAS) from a gateway. Said terminal device is further operative to connect to the first EAS.

In a sixth aspect of the disclosure, there is provided a bootstrap server, the bootstrap server comprises a processor and a memory coupled to the processor. Said memory contains instructions executable by said processor. Said bootstrap server is operative to receive a bootstrap request from a terminal device. Said bootstrap server is further operative to send to the terminal device a bootstrap write request to configure the terminal device with information about the gateway.

In a seventh aspect of the disclosure, there is provided a gateway. The gateway comprises a deciding module configured to decide to discover a first Edge Application Server (EAS) for a terminal device. The gateway further comprises a first sending module configured to send a first message comprising information about the first EAS to the terminal device.

In an embodiment, the gateway further comprises a first obtaining module configured to obtain Edge Configuration Server (ECS) configuration information.

In an embodiment, the gateway further comprises a second obtaining module configured to obtain an identifier of an Edge Enabler Client (EEC) and at least one application client (AC) profile of at least one AC in the terminal device.

In an embodiment, the gateway further comprises a first receiving module configured to receive a registration request comprising an identifier of an Edge Enabler Client (EEC) from the terminal device.

In an embodiment, the gateway further comprises a second sending module configured to send a response for the registration request to the terminal device.

In an embodiment, the gateway further comprises a third sending module configured to send a second message comprising the identifier of EEC and security credentials to an Edge Configuration Server (ECS).

In an embodiment, the gateway further comprises a second receiving module configured to receiving a third message comprising one or more Edge Data Network (EDN) configuration information from the ECS. Each EDN configuration information comprises information about one or more Edge Enabler Servers (EES).

In an embodiment, the gateway further comprises a first selecting module configured to select an EES from the one or more EES.

In an embodiment, the gateway further comprises a fourth sending module configured to sending an EEC registration request comprising the identifier of EEC and security credentials to the selected EES.

In an embodiment, the gateway further comprises a third receiving module configured to receive an EEC registration response from the selected EES.

In an embodiment the gateway further comprises a fourth receiving module configured to receive a registration update request comprising updated registration information from the terminal device.

In an embodiment, the gateway further comprises a fifth sending module configured to send an EEC registration update request comprising the updated registration information to the selected EES.

In an embodiment, the gateway further comprises a fifth receiving module configured to receive an EEC registration update response from the selected EES.

In an embodiment, the gateway further comprises a sixth sending module configured to sending a registration update response to the terminal device.

In an embodiment, the gateway further comprises a seventh sending module configured to sending an EAS discovery request to the selected EES. The EAS discovery request comprises the identifier of EEC and security credentials.

In an embodiment, the gateway further comprises a sixth receiving module configured to receive an EAS discovery response from the selected EES. The EAS discovery response comprises information about one or more discovered EASs.

In an embodiment, the gateway further comprises a second selecting module configured to select the first EAS from the one or more discovered EASs.

In an embodiment, the gateway further comprises a seventh receiving module configured to receive target information notification from the selected EES. The target information notification comprises information about a second EAS.

In an embodiment, the gateway further comprises an eighth sending module configured to send the target information notification to the terminal device.

In an embodiment, the gateway further comprises an eighth receiving module configured to receive from the selected EES a second message for confirming that Application Context Relocation (ACR) has completed.

In an embodiment, the gateway further comprises a ninth sending module configured to send to the terminal device a third message for indicating that an application client in the terminal device can switch application data communication from the first EAS to the second EAS.

In an eighth aspect of the disclosure, there is provided a terminal device. The terminal device comprises a first receiving module configured to receive a first message comprising information about a first Edge Application Server (EAS) from a gateway. The terminal device further comprises a connecting module configured to connect to the first EAS.

In an embodiment, the terminal device further comprises a first sending module configured to send a registration request comprising an identifier of an Edge Enabler Client (EEC) to the gateway.

In an embodiment, the terminal device further comprises a second receiving module configured to receiving a response for the registration request from the gateway.

In an embodiment, the terminal device further comprises a second sending module configured to send a registration update request comprising updated registration information to the gateway.

In an embodiment, the terminal device further comprises a third receiving module configured to receive a registration update response from the gateway.

In an embodiment, the terminal device further comprises a fourth receiving module configured to receive target information notification from the gateway. The target information notification comprises information about a second EAS.

In an embodiment, the terminal device further comprises a fifth receiving module configured to receive from the gateway a third message for indicating that an application client in the terminal device can switch application data communication from the first EAS to the second EAS.

In an embodiment, the terminal device further comprises a switching module configured to switch application data communication from the first EAS to the second EAS.

In an embodiment, the terminal device further comprises a third sending module configured to send a bootstrap request to a bootstrap server.

In an embodiment, the terminal device further comprises a sixth receiving module configured to receive from the bootstrap server a bootstrap write request to configure the terminal device with information about the gateway.

In a ninth aspect of the disclosure, there is provided a bootstrap server. The bootstrap server comprises a receiving module configured to receive a bootstrap request from a terminal device. The bootstrap server further comprises a sending module configured to send to the terminal device a bootstrap write request to configure the terminal device with information about the gateway.

In a tenth aspect of the disclosure, there is provided a computer program product comprising instructions which, when executed on at least one processor, cause the at least one processor to carry out any of the methods according to the first, second and third aspects of the disclosure.

In an eleventh aspect of the disclosure, there is provided a computer-readable storage medium storing instructions which, when executed on at least one processor, cause the at least one processor to carry out any of the methods according to the first, second and third aspects of the disclosure.

Embodiments herein afford many advantages, of which a non-exhaustive list of examples follows. Some embodiments herein can enable the EDGEAPP support to resource constrained devices such as LwM2M devices. In some embodiments herein, there is no impact to 3GPP EDGEAPP architecture and reference points. Some embodiments herein can enable resource constrained devices such as LwM2M devices to communicate with EAS inside EDN in EDGEAPP by using protocol (such as CoAP) designed for the resource constrained devices. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows an example architecture for enabling edge applications according to an embodiment of the present disclosure;

FIG. 2 schematically shows a high level architecture in the fifth generation network according to an embodiment of the present disclosure;

FIG. 3 shows an example architecture for LwM2M according to an embodiment of the present disclosure;

FIG. 4 shows relationship between LwM2M Client, Object, and Resources according to an embodiment of the present disclosure;

FIG. 5 shows a flowchart of a method according to an embodiment of the present disclosure;

FIG. 6 shows a flowchart of a method according to another embodiment of the present disclosure;

FIG. 7 shows a flowchart of a registration method according to an embodiment of the present disclosure;

FIG. 8 shows a flowchart of a service provisioning method according to an embodiment of the present disclosure;

FIG. 9 shows a flowchart of a registration method according to an embodiment of the present disclosure;

FIG. 10 shows a flowchart of a registration update method according to an embodiment of the present disclosure;

FIG. 11 shows a flowchart of a method according to another embodiment of the present disclosure;

FIG. 12 shows a flowchart of a EAS discovery method according to an embodiment of the present disclosure;

FIG. 13 shows a flowchart of an application context relocation (ACR) method according to an embodiment of the present disclosure;

FIG. 14 shows a flowchart of a bootstrap method according to an embodiment of the present disclosure;

FIG. 15 shows a flowchart of a registration method according to another embodiment of the present disclosure;

FIG. 16 shows a flowchart of a registration update method according to another embodiment of the present disclosure;

FIG. 17 shows a flowchart of an method according to another embodiment of the present disclosure;

FIG. 18 shows a flowchart of a method according to another embodiment of the present disclosure;

FIG. 19 shows a flowchart of a method according to another embodiment of the present disclosure;

FIG. 20 shows architecture of LwM2M Support in EDGEAPP according to an embodiment of the present disclosure;

FIG. 21 shows a flowchart of a method according to another embodiment of the present disclosure;

FIG. 22 shows a flowchart of automate ACR procedure according to another embodiment of the present disclosure;

FIG. 23 is a block diagram showing an apparatus suitable for practicing some embodiments of the disclosure;

FIG. 24 is a block diagram showing a gateway according to an embodiment of the disclosure;

FIG. 25 is a block diagram showing a terminal device according to an embodiment of the disclosure; and

FIG. 26 is a block diagram showing a bootstrap server according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code

Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term application server (such as gateway or bootstrap server) refers to any suitable function which can be implemented in a network node (physical or virtual) of a communication network. For example, the network node can be implemented either as a network element on a dedicated hardware, as a software instance running on a dedicated hardware, or as a virtualized function instantiated on an appropriate platform, e.g. on a cloud infrastructure.

Virtualizing means creating virtual versions of apparatuses or devices which may include virtualizing hardware platforms, storage devices and networking resources. As used herein, virtualization can be applied to a provider edge node and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments hosted by one or more of hardware nodes. Further, in embodiments in which the virtual node is not a radio access node or does not require radio connectivity (e.g., a core network node), then the provider edge node or PE may be entirely virtualized.

The functions may be implemented by one or more applications (which may alternatively be called software instances, virtual appliances, network functions, virtual nodes, virtual network functions, etc.) operative to implement some of the features, functions, and/or benefits of some of the embodiments disclosed herein. Applications are run in virtualization environment which provides hardware comprising processing circuitry and memory. Memory contains instructions executable by processing circuitry whereby application is operative to provide one or more of the features, benefits, and/or functions disclosed herein.

Virtualization environment, comprises general-purpose or special-purpose network hardware devices comprising a set of one or more processors or processing circuitry, which may be commercial off-the-shelf (COTS) processors, dedicated Application Specific Integrated Circuits (ASICs), or any other type of processing circuitry including digital or analog hardware components or special purpose processors. Each hardware device may comprise memory which may be non-persistent memory for temporarily storing instructions or software executed by processing circuitry. Each hardware device may comprise one or more network interface controllers (NICs), also known as network interface cards, which include physical network interface. Each hardware device may also include non-transitory, persistent, machine-readable storage media-having stored therein software and/or instructions executable by processing circuitry. Software may include any type of software including software for instantiating one or more virtualization layers (also referred to as hypervisors), software to execute virtual machines as well as software allowing it to execute functions, features and/or benefits described in relation with some embodiments described herein.

Virtual machines, comprise virtual processing, virtual memory, virtual networking or interface and virtual storage, and may be run by a corresponding virtualization layer or hypervisor. Different embodiments of the instance of virtual appliance may be implemented on one or more of virtual machines, and the implementations may be made in different ways.

During operation, processing circuitry executes software to instantiate the hypervisor or virtualization layer, which may sometimes be referred to as a virtual machine monitor (VMM). Virtualization layer may present a virtual operating platform that appears like networking hardware to virtual machine.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

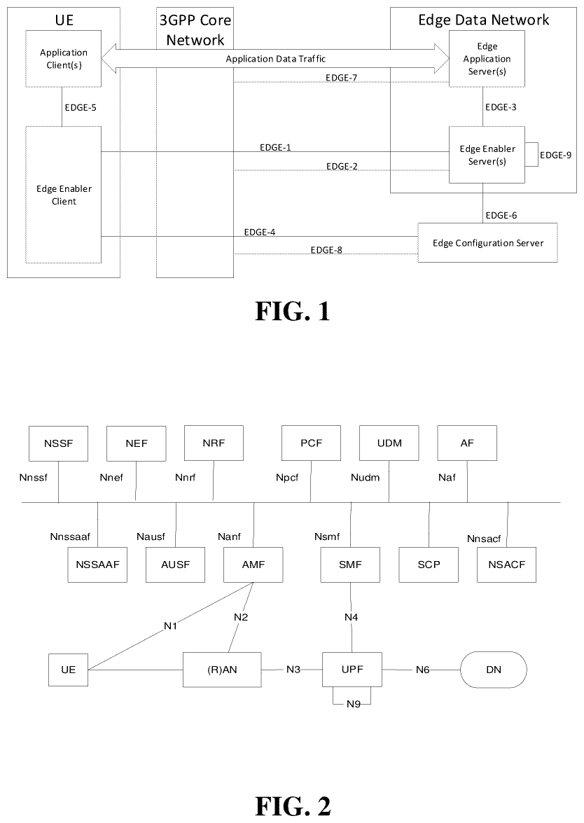

Although the subject matter described herein may be implemented in any appropriate type of system using any suitable components, the embodiments disclosed herein are described in relation to a communication system complied with the exemplary system architectures illustrated in FIGS. 1-3. For simplicity, the system architectures of FIGS. 1-3 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

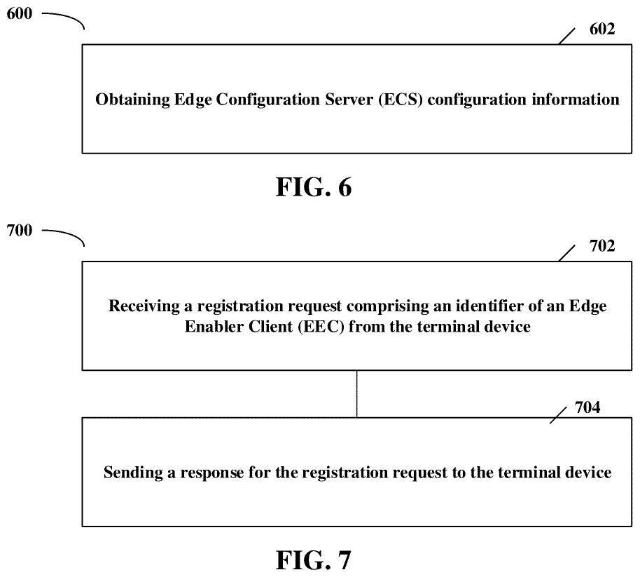

FIG. 1 shows an example architecture for enabling edge applications according to an embodiment of the present disclosure. FIG. 1 is same as Figure 6.2-4 of 3GPP TS 23.558 V17.1.0. The Edge Data Network (EDN) is a local Data Network. Edge Application Server(s) and the Edge Enabler Server(s) are contained within the EDN. The Edge Configuration Server provides configurations related to the EES, including details of the Edge Data Network hosting the (edge enabler server). The UE contains Application Client(s) (ACs) and the Edge Enabler Client (EEC). The Edge Application Server(s), the Edge Enabler Server and the Edge Configuration Server may interact with the 3GPP core network.

For example, Edge Enabler Server (EES) may provide supporting functions needed for EASs and EEC, e.g., EEC registration, EAS discovery and network APIs for EAS and service continuity support.

Edge Enabler Client (EEC) may provide supporting functions needed for AC(s), e.g., retrieval and provisioning of configuration information to enable application data traffic, and EAS discovery.

Edge Configuration Server (ECS) may provide supporting functions needed for the EEC to connect with an EES, e.g., provisioning of Edge configuration information to the EEC, and EES discovery.

Application Client (AC) is the application resident in the UE performing the client function.

Edge Application Server (EAS) is the application server resident in the EDN, performing the server functions. The AC connects to the EAS in order to avail the services of the application with the benefits of Edge Computing.

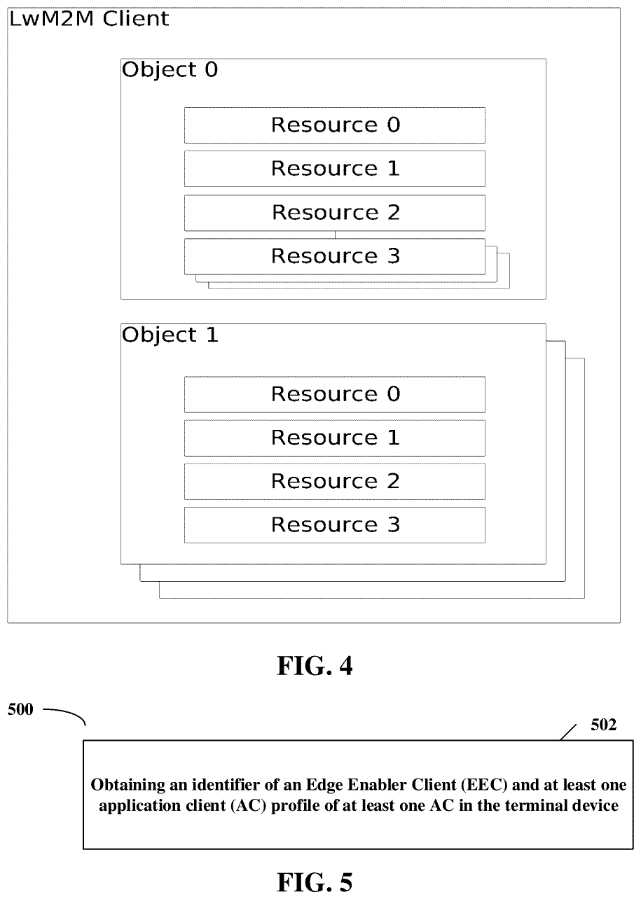

FIG. 2 schematically shows a high level architecture in the fifth generation network according to an embodiment of the present disclosure. For example, the fifth generation network may be 5GS. The architecture of FIG. 2 is same as Figure 4.2.3-1 as described in 3GPP TS 23.501 V17.0.0, the disclosure of which is incorporated by reference herein in its entirety. The system architecture of FIG. 2 may comprise some exemplary elements such as AMF (Access and mobility Function), SMF (Session Management Function), AUSF (Authentication Service Function), UDM

(Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 2. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 2, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 2 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 2 may be responsible for functions such as session management, mobility management, authentication, security, etc. The AUSF, AMF, DN, NEF, NRF, NSSF, PCF, SMF, UDM, UPF, AF, UE, (R)AN, SCP, NSACF may include the functionality for example as defined in clause 6.2 of 3GPP TS 23.501 V17.0.0.

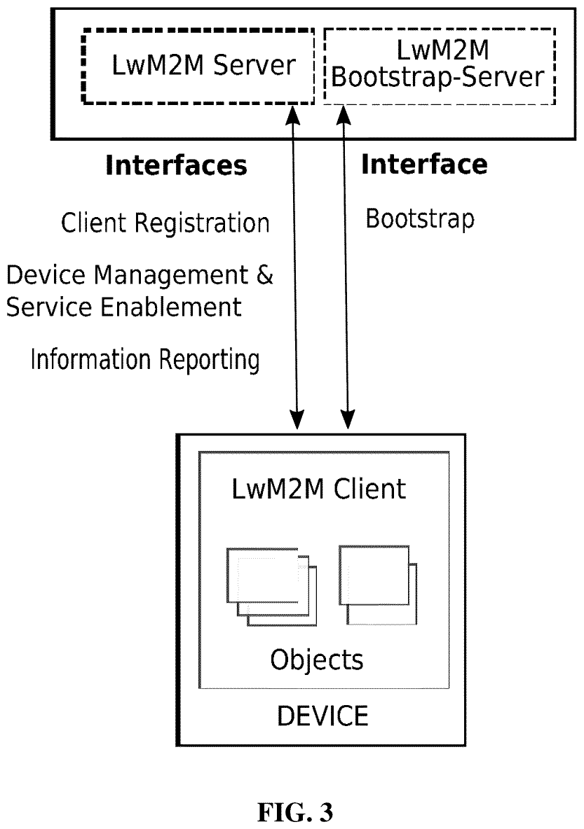

FIG. 3 shows an example architecture for LwM2M according to an embodiment of the present disclosure. FIG. 3 is same as Figure 4.1 of OMA-TS-LightweightM2M_Core-V1_2-20201110-A (short for Lightweight Machine to Machine Technical Specification: Core, Approved Version: 1.2, 2020 Nov. 10, Open Mobile Alliance (OMA), the disclosure of which is incorporated by reference herein in its entirety).

OMA LwM2M defines the application layer communication protocol between a server and a client. The LwM2M protocol stack utilizes the IETF Constrained Application Protocol (CoAP) as the underlying transport protocol over UDP (User Datagram Protocol) and SMS (Short Messaging Service) bearers. CoAP defines the message header, request/response code, message options and transmission mechanisms.

LwM2M defines a simple resource model where each piece of information made available by the LwM2M Client is a resource. Resources are logically organized into Objects. The LwM2M Client can have many resources and each resource belongs to an object. Resources and Objects have the capability to support multiple instances. A Resource may have multiple instances referred to as a Resource Instance. The LwM2M Server supports several CRUD (Create, Retrieve, Update and Delete) operations. The LwM2M Client also has the capability to instantiate a Resource instance.

FIG. 4 shows relationship between LwM2M Client, Object, and Resources according to an embodiment of the present disclosure. FIG. 4 is same as Figure 7.1-1 of OMA-TS-LightweightM2M_Core-V1_2-20201110-A.

The LwM2M Enabler defines a simple resource model where each piece of information made available by the LwM2M Client is a Resource. Resources are logically organized into Objects. The LwM2M Client may have any number of Resources, each of which belongs to an Object. Section 7.1 of OMA-TS-LightweightM2M_Core-V1_2-20201110-A describes the Resource Model.

FIG. 5 shows a flowchart of a method according to an embodiment of the present disclosure, which may be performed by an apparatus implemented in or at or as a gateway or communicatively coupled to the gateway. As such, the apparatus may provide means or modules for accomplishing various parts of the method 500 as well as means or modules for accomplishing other processes in conjunction with other components.

At block 502, the gateway may obtain an identifier of an Edge Enabler Client (EEC) and at least one application client (AC) profile of at least one AC in the terminal device.

The EEC may provide supporting functions needed for application client(s). Functionalities of EEC may comprise a) retrieval and provisioning of configuration information to enable the exchange of Application Data Traffic with the EAS; and b) discovery of EASs available in the EDN. In an embodiment, the EEC may be same as the EEC as described in 3GPP TS 23.558 V17.1.0.

AC is an application resident in the terminal device performing a client function. The AC may comprise various types of applications and the disclosure has not limit on it.

An AC profile may include information about AC. For example, such information may be used to determine services and service characteristics required. In an embodiment, the AC profile may be same as the AC profile as described in section 8.2.2 of 3GPP TS 23.558 V17.1.0.

The gateway may obtain the identifier of the EEC and at least one AC profile of at least one AC in the terminal device in various ways. For example, this information may be reported to the gateway by the terminal device. The gateway may obtain this information from another device such as network management device. The operator may input this information to the gateway.

In an embodiment, the gateway may be an LwM2M EDGEAPP Gateway. The terminal device information (including AC profile(s) and EEC) may be onboarded to LwM2M EDGEAPP Gateway. Then LwM2M EDGEAPP Gateway has EEC ID and AC profile(s) information.

FIG. 6 shows a flowchart of a method according to another embodiment of the present disclosure, which may be performed by an apparatus implemented in or at or as a gateway or communicatively coupled to the gateway. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the gateway may obtain Edge Configuration Server (ECS) configuration information.

ECS may provide supporting functions needed for the EEC to connect with an EES. In an embodiment, the ECS may be same as the ECS as described in section 6.3.4 of 3GPP TS 23.558 V17.1.0.

ECS configuration information may comprise one or more endpoint information (e.g. Uniform Resource Identifier(s) (URI), Fully Qualified Domain Name(s) (FQDN), Internet protocol (IP) address(es)) of ECS(s), and optionally the corresponding ECS Provider Identifier.

In an embodiment, ECS configuration information may be same as the ECS configuration information as described in Table 8.3.2.1-1 of 3GPP TS 23.558 V17.1.0.

The gateway may obtain the ECS configuration information in various ways. For example, the ECS configuration information may be pre-configured in the gateway. The ECS configuration information may be configured by a user. The ECS configuration information may be provisioned by MNO (Mobile Network Operator).

In an embodiment, the gateway may initiate the ECS discovery procedure. ECS discovery procedure is to provide the ECS configuration information (e.g., URL and/or IP Address) to the gateway. ECS configuration information can be pre-configured or provisioned by communications service providers (CSPs).

FIG. 7 shows a flowchart of a registration method according to an embodiment of the present disclosure, which may be performed by an apparatus implemented in or at or as a gateway or communicatively coupled to the gateway. As such, the apparatus may provide means or modules for accomplishing various parts of the method 700 as well as means or modules for accomplishing other processes in conjunction with other components. For some parts which have been described in the above embodiments, the description thereof is omitted here for brevity.

At block 702, the gateway may receive a registration request comprising an identifier of an Edge Enabler Client (EEC) from a terminal device.

The identifier of an EEC may be a globally unique value that identifies the EEC. In an embodiment, the identifier of an EEC may be same as the Edge Enabler Client Identifier (EECID) as described in 3GPP TS 23.558 V17.1.0.

The registration request may be used by the terminal device such as LwM2M Client to register with one or more server (such as gateway or LwM2M Server), maintain each registration, and de-register from an server (such as gateway or LwM2M Server). When registering, the terminal device such as LwM2M Client may provide the information required by the gateway as well as optional parameters. The gateway may maintain the registration session based upon the configured parameters (e.g. Lifetime, security context). The terminal device such as LwM2M Client may periodically perform an update of its registration information to the registered gateway by performing an update operation. If the lifetime of a registration expires without receiving an update from the terminal device such as LwM2M Client, the gateway may consider it as de-registration.

In an embodiment, the registration request may be same as a corresponding registration request of the registration operation or registration update request of update operation as described in OMA-TS-LightweightM2M_Core-V1_2-20201110-A. In this embodiment, the LwM2M endpoint name may use EEC ID.

In an embodiment, the registration request may be a registration update request.

In an embodiment, the registration request may comprise any suitable parameter which can be comprised in EEC registration request for example as described in 3GPP TS 23.558 V17.1.0.

Upon receiving the registration request from the terminal device, the gateway may process the registration request. For example, the gateway may record the connection information of the registration request (e.g. source IP (Internet protocol) address and port or MSISDN (Mobile Subscriber ISDN (Integrated Services Digital Network) Number)) and uses this information for all future interactions with that terminal device. If the terminal device sends a registration request to the gateway even though the gateway has registration information of the terminal device, the gateway may remove the existing registration information and performs a new registration operation. This situation happens when the terminal device forgets the state of the gateway (e.g. factory reset).

At block 704, the gateway may send a response for the registration request to the terminal device. The response may comprise a registration result. The response may further comprise any other suitable information.

In an embodiment, when the registration request is the registration operation or update operation as described in section 6.2 of OMA-TS-LightweightM2M_Core-V1_2-20201110-A, the response may be a corresponding response as described in section 6.2 of OMA-TS-LightweightM2M_Core-V1_2-20201110-A.

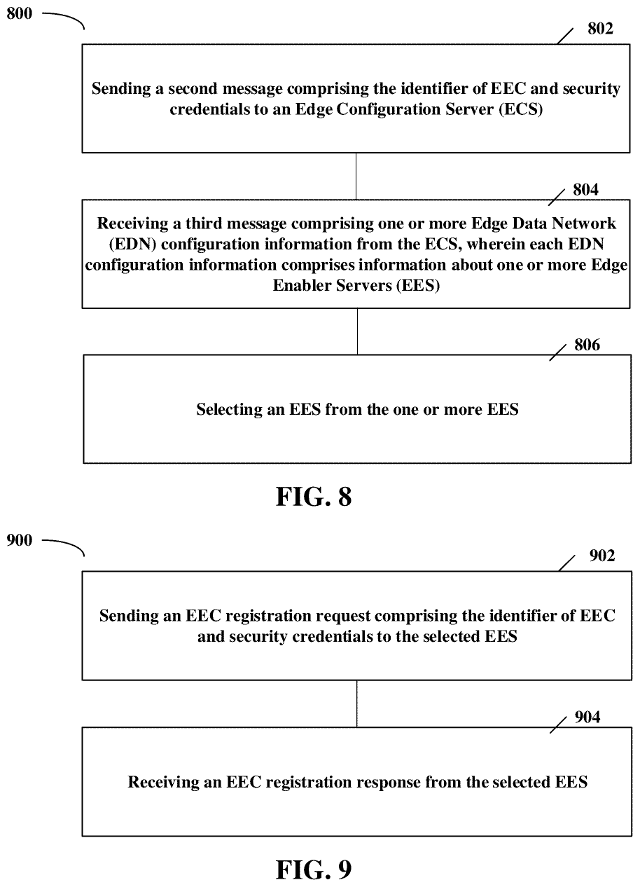

FIG. 8 shows a flowchart of a service provisioning method according to an embodiment of the present disclosure, which may be performed by an apparatus implemented in or at or as a gateway or communicatively coupled to the gateway. As such, the apparatus may provide means or modules for accomplishing various parts of the method 800 as well as means or modules for accomplishing other processes in conjunction with other components. For some parts which have been described in the above embodiments, the description thereof is omitted here for brevity.

Service provisioning allows configuring the gateway with information about available Edge Computing services, for example based on the hosting UEs location, service requirements, service preferences and connectivity. This configuration includes the necessary address information for the gateway to establish connection with the EES(s).

Service provisioning method support the following models: Request/Response model and Subscribe/Notify model.

In an embodiment, the service provisioning method may be same as the service provisioning procedure as described in section 8.3.3 of 3GPP TS 23.558 V17.1.0 except that the gateway initiates the service provisioning procedure.

In an embodiment, the gateway may initiate the service provisioning procedure on behalf of the terminal device.

In an embodiment, the service provisioning procedure may be triggered by the registration request received from the terminal device at block 702.

At block 802, the gateway may send a second message comprising the identifier of EEC and security credentials to an Edge Configuration Server (ECS). In an embodiment, the identifier of EEC has been received at block 702 of FIG. 7. In an embodiment, the gateway has obtain the ECS configuration information at block 602 of FIG. 6. The security credentials may be obtained during authentication and authorization between the gateway and ECS.

In an embodiment, the second message may be a service provisioning request or a service provisioning subscription request or a service provisioning subscription update request as described in section 8.3.3 of 3GPP TS 23.558 V17.1.0.

The ECS may process the second message for example as described in section 8.3.3 of 3GPP TS 23.558 V17.1.0.

At block 804, the gateway may receive a third message comprising one or more Edge Data Network (EDN) configuration information from the ECS. Each EDN configuration information comprises information about one or more Edge Enabler Servers (EES).

In an embodiment, the third message may be a service provisioning response or a service provisioning subscription response or a service provisioning subscription update response or a provisioning notification as described in section 8.3.3 of 3GPP TS 23.558 V17.1.0.

At block 806, the gateway may select an EES from the one or more EES. The selection logic can be based on at least one predefined rule configured in the gateway. In an embodiment, the gateway may select an EES from the one or more EES based on services area and/or service continuity support.

The service area may comprise EES Topological Service Area or EES Geographical Service Area. For example, a Topological Service Area is defined in relationship with a UE's point of connection to the network, such as: a collection of Cell IDs (identifiers), Tracking Area Identities or the PLMN (Public Land Mobile Network) ID. Any UE that is attached to the Core Network from a cell whose ID is in the Topological Service Area, can be served by the EES that is configured to serve that Topological Service Area. A Geographical Service Area is an area that is specified by geographical units, such as: Geographical coordinates, an area that is defined as a circle whose centre is denoted by geographical coordinates, an area that is defined by a polygon whose corners are denoted by geographical coordinates. A Geographical Service Area can also be expressed in other ways such as: well-known buildings, parks, arenas, civic addresses or ZIP (Zone Improvement Plan) code etc. EES can be configured to serve UEs that are in a specified geographical area and deny service from UEs that are not located in that area.

The service continuity support may indicate if the EES supports service continuity or not.

FIG. 9 shows a flowchart of a registration method according to an embodiment of the present disclosure, which may be performed by an apparatus implemented in or at or as a gateway or communicatively coupled to the gateway. As such, the apparatus may provide means or modules for accomplishing various parts of the method 900 as well as means or modules for accomplishing other processes in conjunction with other components. For some parts which have been described in the above embodiments, the description thereof is omitted here for brevity.

In an embodiment, the gateway may initiate the EEC registration procedure on behalf of the terminal device.

In an embodiment, the EEC registration procedure may be triggered by the registration request received from the terminal device at block 702.

At block 902, the gateway may send an EEC registration request comprising the identifier of EEC and security credentials to the selected EES. In an embodiment, the EEC registration request may be same as the EEC registration request as described in section 8.4.2.2.2 of 3GPP TS 23.558 V17.1.0.

At block 904, the gateway may receive an EEC registration response from the selected EES. In an embodiment, the EEC registration response may be same as the EEC registration response as described in section 8.4.2.2.2 of 3GPP TS 23.558 V17.1.0.

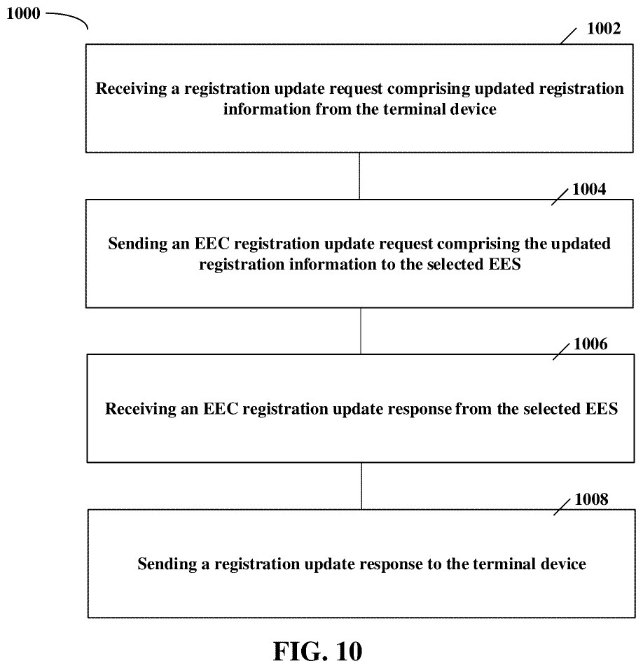

FIG. 10 shows a flowchart of a registration update method according to an embodiment of the present disclosure, which may be performed by an apparatus implemented in or at or as a gateway or communicatively coupled to the gateway. As such, the apparatus may provide means or modules for accomplishing various parts of the method 1000 as well as means or modules for accomplishing other processes in conjunction with other components. For some parts which have been described in the above embodiments, the description thereof is omitted here for brevity.

At block 1002, the gateway may receive a registration update request comprising updated registration information from the terminal device. For example, when any of the parameters (such as the parameters listed in Table: 6.2.2.-1 Update Parameters of OMA-TS-LightweightM2M_Core-V1_2-20201110-A and/or the parameters of EEC registration update request of 3GPP TS 23.558 V17.1.0) that can be comprised in the registration request changes, the terminal device may send the registration update request to the gateway.

In an embodiment, the registration update request may be same as the corresponding registration update of the Register Operation as described in section 6.2.2 of OMA-TS-LightweightM2M_Core-V1_2-20201110-A.

At block 1004, the gateway may send an EEC registration update request comprising the updated registration information to the selected EES. The EEC registration update request may be same as the EEC registration update request of 3GPP TS 23.558 V17.1.0. In an embodiment, when the updated registration information is not related to the EEC registration update request, blocks 1004 and 1006 may be skipped.

At block 1006, the gateway may receive an EEC registration update response from the selected EES. The EEC registration update response may be same as the EEC registration update response of 3GPP TS 23.558 V17.1.0.

At block 1008, the gateway may send a registration update response to the terminal device. In an embodiment, the registration update response may be same as a corresponding registration update response of the Register Operation as described in section 6.2.2 of OMA-TS-LightweightM2M_Core-V1_2-20201110-A.

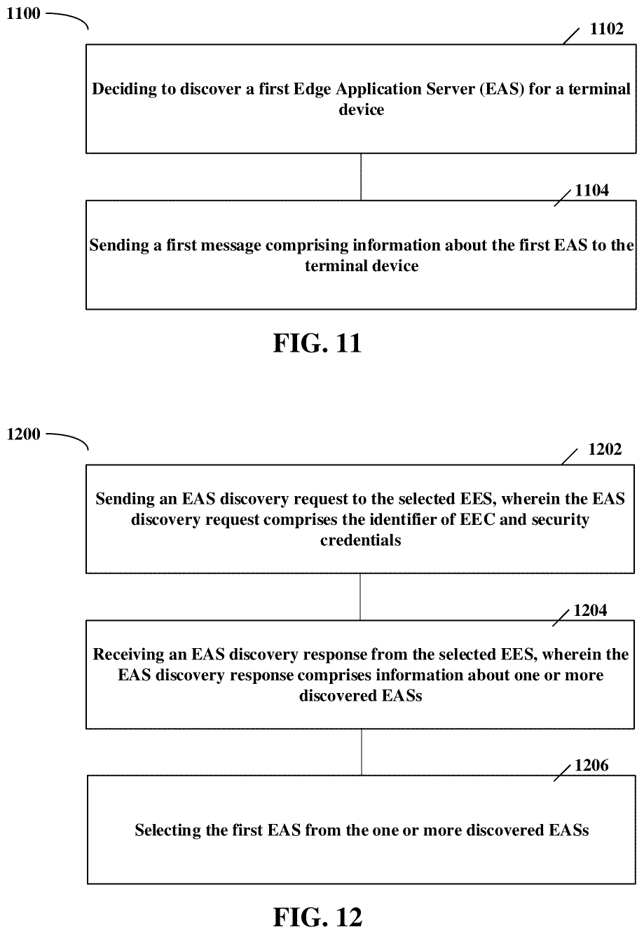

FIG. 11 shows a flowchart of a method according to another embodiment of the present disclosure, which may be performed by an apparatus implemented in or at or as a gateway or communicatively coupled to the gateway. As such, the apparatus may provide means or modules for accomplishing various parts of the method 1100 as well as means or modules for accomplishing other processes in conjunction with other components. For some parts which have been described in the above embodiments, the description thereof is omitted here for brevity.

At block 1102, the gateway may decide to discover a first Edge Application Server (EAS) for a terminal device. The terminal device may have registered in the gateway. For example, the method 700 has been performed.

EAS may be an application server resident in an EDN, performing the server functions. The application client (AC) in the terminal device can connect to the EAS in order to avail the services of the application of EAS with the benefits of Edge Computing. It is possible that the server functions of an application are available only as an EAS. However, it is also possible that certain server functions are available both at the edge and in the cloud, as an EAS and an Application Server resident in the cloud respectively. The server functions offered by an EAS and its cloud Application Server counterpart may be the same or may differ; if they differ, the Application Data Traffic exchanged with the AC may also be different.

In an embodiment, the EAS may be same as the EAS as described in 3GPP TS 23.558 V17.1.0.

The gateway may be triggered to discover the first EAS for the terminal device due to various reasons such as location change of the terminal device, policy, deployment change of EAS, indication from another network device, overload of EAS, etc.

In an embodiment, the gateway may decide to discover the first for the terminal device based on a policy. The policy may be any suitable policy. For example, the policy can be determined by the operator.

In an embodiment, the policy comprises at least one of: a change of a geographical location of the terminal device, a change of a topological location of the terminal device, a change of deployment of EAS, or a reception of a registration request from the terminal device.

At block 1104, the gateway may send a first message comprising information about the first EAS to the terminal device. The information about the first EAS may comprise endpoint information (e.g. URI, FQDN, IP address) of the first EAS.

In an embodiment, the first message comprises at least one of: a response for a registration request from the terminal device, or a write request. The write request may be same as the Write Operation as described in section 6.3.3 of OMA-TS-LightweightM2M_Core-V1_2-20201110-A.

In an embodiment, the information about the first EAS may comprise at least one of an identifier of the first EAS, endpoint information of the first EAS, or an identity of an application client (AC).

In an embodiment, the information about the first EAS may further comprise a type of the first EAS and the type of the first EAS is set as source. The term “source” may mean that the first EAS is ready to serve AC on the terminal device and the terminal device can connect to the first EAS in order to avail the services of the application of the first EAS with the benefits of Edge Computing.

In an embodiment, the gateway may receive a response for the first message from the terminal device. The response may comprise a process result of the first message. For example, when the terminal device has received and stored the information about the first EAS, it may send a successful response to gateway.

FIG. 12 shows a flowchart of a EAS discovery method according to an embodiment of the present disclosure, which may be performed by an apparatus implemented in or at or as a gateway or communicatively coupled to the gateway. As such, the apparatus may provide means or modules for accomplishing various parts of the method 1200 as well as means or modules for accomplishing other processes in conjunction with other components. For some parts which have been described in the above embodiments, the description thereof is omitted here for brevity.

At block 1202, the gateway may send an EAS discovery request to the selected EES. The EAS discovery request comprises the identifier of EEC and security credentials. In an embodiment, the EAS discovery request further comprises location information of the terminal device. For example, the gateway may retrieve location information of the terminal device from 3GPP networks. In another embodiment, the registration request or registration update request may comprise location information of the terminal device. The security credentials may be obtained during authentication and authorization between the gateway and ECS.

At block 1204, the gateway may receive an EAS discovery response from the selected EES. The EAS discovery response comprises information about one or more discovered EASs. The information may comprise endpoint information (e.g. URI, FQDN, IP address) of the one or more discovered EASs.

At block 1206, the gateway may select the first EAS from the one or more discovered EASs. The selection logic can be based on a predefined rule(s) configured in gateway. In an embodiment, the gateway may select the first EAS from the discovered EASs based on at least one of service area, transport support or service continuity support.

The service area may comprise EAS Topological Service Area or EAS Geographical Service Area. For example, a Topological Service Area is defined in relationship with a UE's point of connection to the network, such as: a collection of Cell IDs (identifiers), Tracking Area Identities or the PLMN (Public Land Mobile Network) ID. Any UE that is attached to the Core Network from a cell whose ID is in the Topological Service Area, can be served by the EAS that is configured to serve that Topological Service Area. A Geographical Service Area is an area that is specified by geographical units, such as: Geographical coordinates, an area that is defined as a circle whose centre is denoted by geographical coordinates, an area that is defined by a polygon whose corners are denoted by geographical coordinates. A Geographical Service Area can also be expressed in other ways such as: a well-known buildings, parks, arenas, civic addresses or ZIP (Zone Improvement Plan) code etc. EAS can be configured to serve UEs that are in a specified geographical area and deny service from UEs that are not located in that area.

Transport support may indicates if the EES supports a specific transport protocol or not. For example, the transport protocol may comprise UDP (User Datagram Protocol), NIDD (Non-IP Data Delivery), etc.

The service continuity support may indicate if the EES supports service continuity or not.

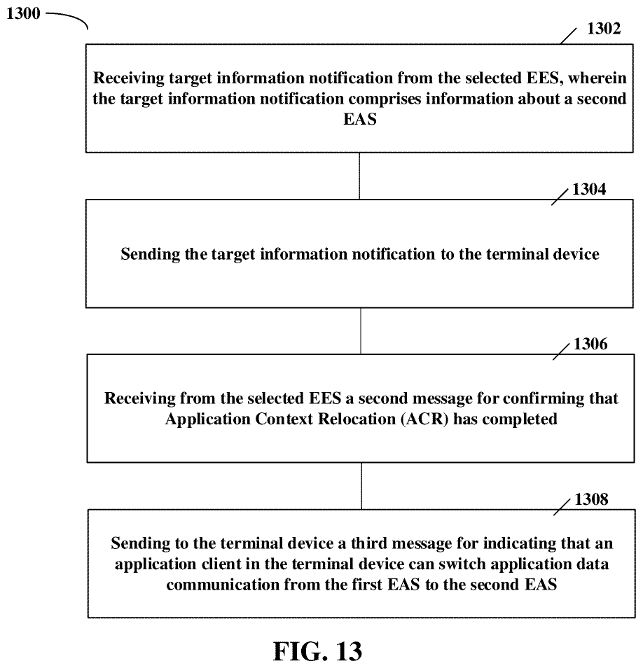

FIG. 13 shows a flowchart of an application context relocation (ACR) method according to an embodiment of the present disclosure, which may be performed by an apparatus implemented in or at or as a gateway or communicatively coupled to the gateway. As such, the apparatus may provide means or modules for accomplishing various parts of the method 1300 as well as means or modules for accomplishing other processes in conjunction with other components. For some parts which have been described in the above embodiments, the description thereof is omitted here for brevity.

The application context relocation procedure can be triggered due to various reasons, such as terminal device mobility (including predictive or expected terminal device mobility), overload situations in S-EAS (source EAS) or EDN, and maintenance aspects such as graceful shutdown of an EAS.

For example, when a terminal device moves to a new location, different EASs can be more suitable for serving the ACs in the terminal device. Such transitions can result from a non-mobility event also, requiring support from the enabling layer to maintain the continuity of the service.

Generally, the S-EAS is associated with an application context. To support service continuity, the application context from the S-EAS is transferred to a T-EAS (target EAS).

At block 1302, the gateway may receive target information notification from the selected EES (e.g., S-EES). The target information notification comprises information about a second EAS (e.g., T-EAS). The information about the second EAS may comprise endpoint information (e.g. URI, FQDN, IP address) of the second EAS.

In an embodiment, as described in section 8.8.2.4 of 3GPP TS 23.558 V17.1.0, S-EAS may detect the need of ACR locally or is notified by the S-EES via ACR management notifications for “ACR monitoring” events. The S-EAS makes the decision about whether to perform the ACR, and starts the ACR at a proper time. In this embodiment, the gateway may receive target information notification from the selected EES (e.g., S-EES).

In an embodiment, as described in section 8.8.2.5 of 3GPP TS 23.558 V17.1.0, S-EES can detect, decide and execute the ACR from the S-EAS to the T-EAS. In this embodiment, the gateway may receive target information notification from the selected EES (e.g., S-EES).

At block 1304, the gateway may send the target information notification to the terminal device.

In an embodiment, the target information notification further comprises information about a target EES. The information about the target EES may comprise endpoint information (e.g. URI, FQDN, IP address) of the target EES.

In an embodiment, the target information notification is sent to the terminal device in a write request for writing the information about the second EAS to the terminal device.

In an embodiment, the information about the second EAS may comprise at least one of an identifier of the second EAS, endpoint information of the second EAS, or an identity of an application client (AC).

In an embodiment, the information about the second EAS may further comprise a type of the second EAS and the type of the second EAS is set as target. EAS instance is being marked as ‘target’ which means that this EAS is just regarded as a placeholder but not yet ready to serve AC since the Application Context relocation is not completed.

In an embodiment, the target information notification indicates that the second EAS is not ready to serve an application client in the terminal device.

At block 1306, the gateway may receive from the selected EES a second message for confirming that Application Context Relocation (ACR) has completed.

In an embodiment, as described in section 8.8.2.4 of 3GPP TS 23.558 V17.1.0, S-EES sends the ACR information notification (ACR complete) message to the EEC to confirm that the ACR has completed. In this embodiment, the gateway may receive ACR information notification (i.e., the second message) from the selected EES (e.g., S-EES).

In an embodiment, as described in section 8.8.2.5 of 3GPP TS 23.558 V17.1.0, S-EES sends the ACR information notification (ACR complete) message to the EEC to confirm that the ACR has completed. In this embodiment, the gateway may receive ACR information notification (i.e., the second message) from the selected EES (e.g., S-EES).

At block 1308, the gateway may send to the terminal device a third message for indicating that an application client in the terminal device can switch application data communication from the first EAS to the second EAS.

In an embodiment, the third message is a write request for updating a type of the second EAS as source.

In an embodiment, the terminal device comprises at least one of a resource constrained device, an Internet of thing device, or a lightweight machine to machine (LwM2M) client.

In an embodiment, a communication between the terminal device and the gateway uses at least one of Internet of Thing (IoT) protocol, LwM2M Protocol, or Constrained Application Protocol (CoAP).

In an embodiment, a communication between an Edge Configuration Server and the gateway and/or a communication between an Edge Enabler Server and the gateway use Hypertext Transfer Protocol (HTTP).

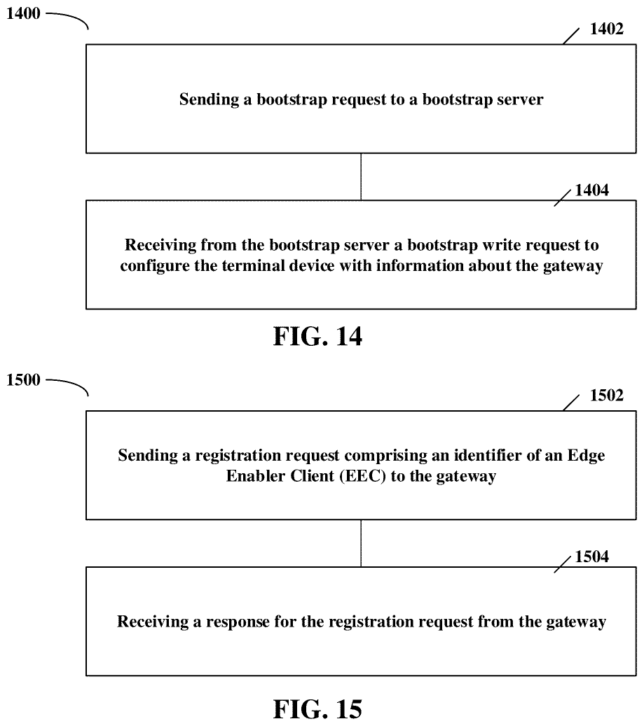

FIG. 14 shows a flowchart of a bootstrap method according to an embodiment of the present disclosure, which may be performed by an apparatus implemented in or at or as a terminal device or communicatively coupled to the terminal device. As such, the apparatus may provide means or modules for accomplishing various parts of the method 1400 as well as means or modules for accomplishing other processes in conjunction with other components. For some parts which have been described in the above embodiments, the description thereof is omitted here for brevity.

At block 1402, the terminal device may send a bootstrap request to a bootstrap server. In an embodiment, the bootstrap request may be same as the bootstrap request as described in sections 6.1 of OMA-TS-LightweightM2M_Core-V1_2-20201110-A.

At block 1404, the terminal device may receive from the bootstrap server a bootstrap write request to configure the terminal device with information about the gateway. The information about the gateway may comprise endpoint information (e.g. URI, FQDN, IP address) of the gateway. In an embodiment, the bootstrap write request may be same as the bootstrap write as described in sections 6.1 of OMA-TS-LightweightM2M_Core-V1_2-20201110-A.

FIG. 15 shows a flowchart of a registration method according to another embodiment of the present disclosure, which may be performed by an apparatus implemented in or at or as a terminal device or communicatively coupled to the terminal device. As such, the apparatus may provide means or modules for accomplishing various parts of the method 1500 as well as means or modules for accomplishing other processes in conjunction with other components. For some parts which have been described in the above embodiments, the description thereof is omitted here for brevity.

At block 1502, the terminal device may send a registration request comprising an identifier of an Edge Enabler Client (EEC) to the gateway.

At block 1504, the terminal device may receive a response for the registration request from the gateway. The response may comprise a registration result. The response may further comprise any other suitable information.

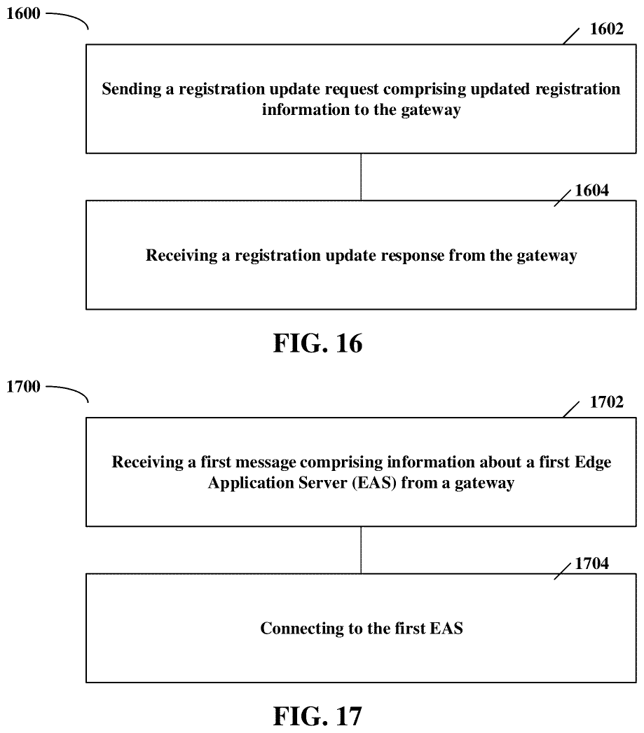

FIG. 16 shows a flowchart of a registration update method according to another embodiment of the present disclosure, which may be performed by an apparatus implemented in or at or as a terminal device or communicatively coupled to the terminal device. As such, the apparatus may provide means or modules for accomplishing various parts of the method 1600 as well as means or modules for accomplishing other processes in conjunction with other components. For some parts which have been described in the above embodiments, the description thereof is omitted here for brevity.

At block 1602, the terminal device may send a registration update request comprising updated registration information to the gateway.

At block 1604, the terminal device may receive a registration update response from the gateway. The response may comprise a registration update result. The response may further comprise any other suitable information.

FIG. 17 shows a flowchart of an method according to another embodiment of the present disclosure, which may be performed by an apparatus implemented in or at or as a terminal device or communicatively coupled to the terminal device. As such, the apparatus may provide means or modules for accomplishing various parts of the method 1700 as well as means or modules for accomplishing other processes in conjunction with other components. For some parts which have been described in the above embodiments, the description thereof is omitted here for brevity.

At block 1702, the terminal device may receive a first message comprising information about a first Edge Application Server (EAS) from a gateway. In an embodiment, the first message comprises at least one of a response for a registration request from the terminal device, or a write request. For example, the gateway may send the first message at block 1104 of FIG. 11, and then the terminal device may receive the first message from the gateway.

In an embodiment, the information about the first EAS comprises at least one of an identifier of the first EAS, endpoint information of the first EAS, or an identity of an application client (AC).

In an embodiment, the information about the first EAS further comprises a type of the first EAS and the type of the first EAS is set as source.

At block 1704, the terminal device may connect to the first EAS. For example, the terminal device may avail at least one service of at least one application in the first EAS. The terminal device may connect to the first EAS for any other suitable purpose, such as the operation supported in Client Registration Interface and Device Management and Service Enablement Interface as described in sections 6.2 and 6.3 of OMA-TS-LightweightM2M_Core-V1_2-20201110-A.

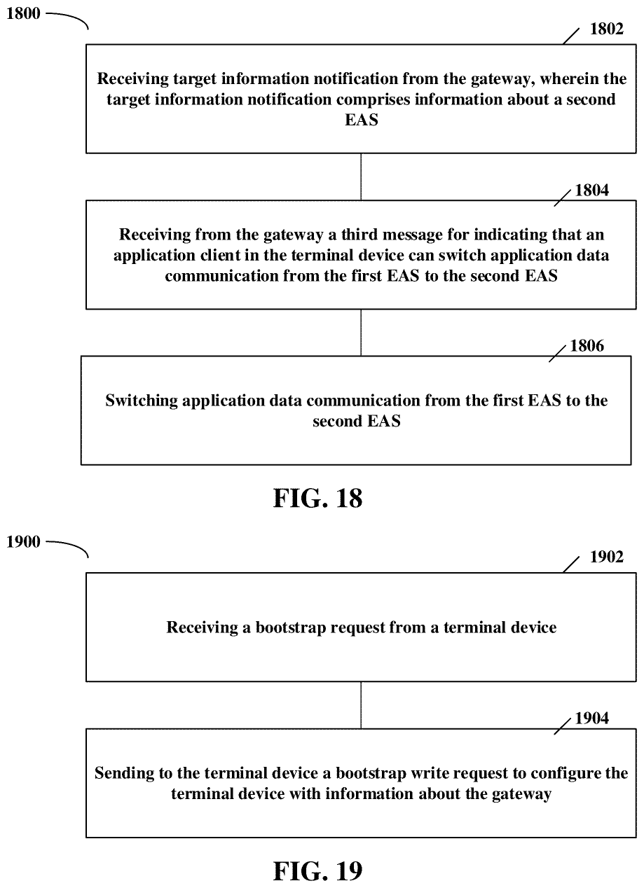

FIG. 18 shows a flowchart of a method according to another embodiment of the present disclosure, which may be performed by an apparatus implemented in or at or as a terminal device or communicatively coupled to the terminal device. As such, the apparatus may provide means or modules for accomplishing various parts of the method 1800 as well as means or modules for accomplishing other processes in conjunction with other components. For some parts which have been described in the above embodiments, the description thereof is omitted here for brevity.

At block 1802, the terminal device may receive target information notification from the gateway. The target information notification comprises information about a second EAS.

In an embodiment, the target information notification is received from the gateway in a write request for writing the information about the second EAS to the terminal device.

In an embodiment, the information about the second EAS comprises at least one of an identifier of the second EAS, endpoint information of the second EAS, or an identity of an application client (AC).

In an embodiment, the information about the second EAS further comprises a type of the second EAS and the type of the second EAS is set as target.

In an embodiment, the target information notification indicates that the second EAS is not ready to serve an application client in the terminal device.

At block 1804, the terminal device may receive from the gateway a third message for indicating that an application client in the terminal device can switch application data communication from the first EAS to the second EAS.

At block 1806, the terminal device may switch application data communication from the first EAS to the second EAS

In an embodiment, the third message is a write request for updating a type of the second EAS as source.

FIG. 19 shows a flowchart of a method according to another embodiment of the present disclosure, which may be performed by an apparatus implemented in or at or as a bootstrap server or communicatively coupled to the bootstrap server. As such, the apparatus may provide means or modules for accomplishing various parts of the method 1800 as well as means or modules for accomplishing other processes in conjunction with other components. For some parts which have been described in the above embodiments, the description thereof is omitted here for brevity.

At block 1902, the bootstrap server may receive a bootstrap request from a terminal device. The bootstrap request may be same as the bootstrap request as described in sections 6.1.3.3 of OMA-TS-LightweightM2M_Core-V1_2-20201110-A.

At block 1904, the bootstrap server may send to the terminal device a bootstrap write request to configure the terminal device with information about the gateway. The bootstrap write request may be same as the bootstrap write as described in sections 6.1.3.3 of OMA-TS-LightweightM2M_Core-V1_2-20201110-A. The information about the gateway may comprise endpoint information (e.g. URI, FQDN, IP address) of the gateway.

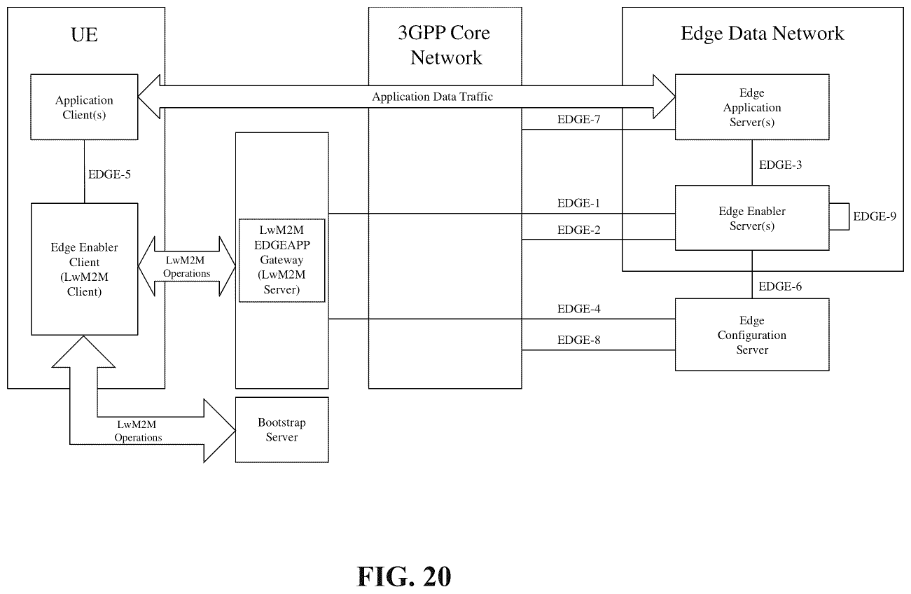

FIG. 20 shows architecture of LwM2M Support in EDGEAPP according to an embodiment of the present disclosure.

As shown in FIG. 20, the gateway according to embodiments of the present disclosure is implemented as an ‘LwM2M EDGEAPP Gateway’ (acting as both a LwM2M server in the LwM2M architecture and an EEC in the architecture for enabling edge applications) which is used as a broker between LwM2M-based EEC (acting as LwM2M Client) and ECS/EEC. LwM2M-based EEC inside a constrained device can communicate with ECS/EEC. There is no impact to 3GPP EDGEAPP architecture and reference points since the gateway acts as both the LwM2M server and the EEC. LwM2M EDGEAPP Gateway may be implemented as a function of Device Management platform which is trusted by devices (such as constrained devices). The other network elements are same as the corresponding network elements of FIG. 1.

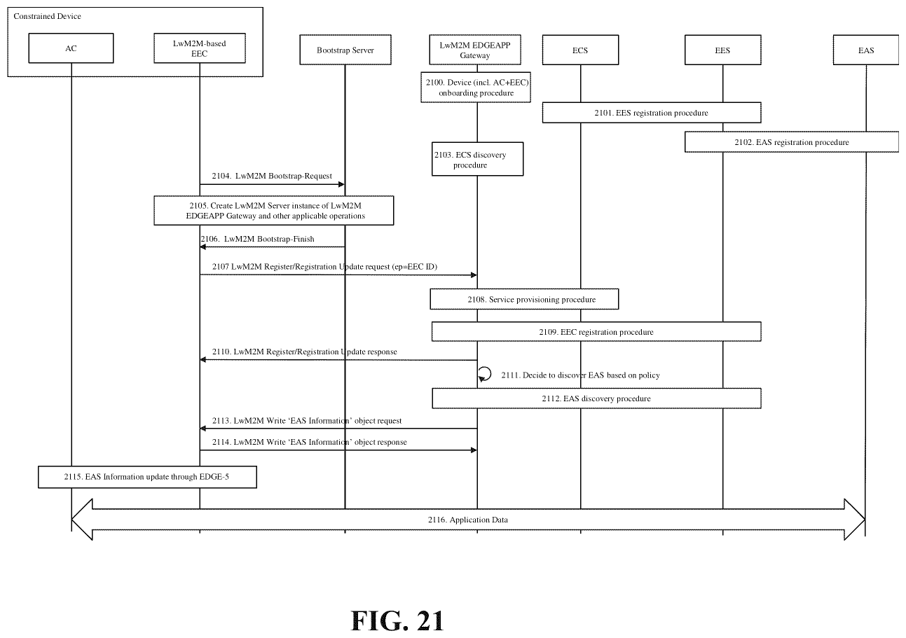

FIG. 21 shows a flowchart of a method according to another embodiment of the present disclosure. This method may be implemented in the architecture of FIG. 20.

At step 2100, information about the constrained device (including AC(s) and EEC) is onboarded to LwM2M EDGEAPP Gateway. Then LwM2M EDGEAPP Gateway has EEC ID and

AC profile(s) information.

At step 2101, the EES initiates the EES registration procedure.

At step 2102, the EAS initiates the EAS registration procedure.

At step 2103, LwM2M EDGEAPP Gateway initiates the ECS discovery procedure. As described in section 8.3.2 of 3GPPTS 23.558 V17.1.0, ECS discovery procedure is to provide the ECS configuration information (e.g., URL and/or IP Address) to the edge client. ECS configuration information can be pre-configured or provisioned by CSP.

At step 2104, LwM2M-based EEC initiates bootstrap operation toward Bootstrap Server.

At step 2105, Bootstrap Server creates an LwM2M Server object instance representing LwM2M EDGEAPP Gateway in the bootstrapping procedure so that LwM2M-based EEC can communicate with LwM2M EDGEAPP Gateway.

At step 2106, Bootstrap Server indicates that the bootstrap procedure finishes.

At step 2107, LwM2M-based EEC sends Register/Registration Update request to LwM2M EDGEAPP Gateway. EEC ID is included in the request. The LwM2M endpoint name may use EEC ID.

At step 2108, LwM2M EDGEAPP Gateway initiates the Service provisioning procedure. As described in section 8.3.3 of 3GPPTS 23.558 V17.1.0, Service provisioning procedure is to discover the EES(s) for the edge client.

The request may include EEC ID and security credentials.

The response includes one or more EDN configuration information where each EDN configuration contains one or more EES(s) information.

After receiving the response, LwM2M EDGEAPP Gateway further selects an EES on behalf of LwM2M-based EEC. The selection logic can be based on some predefined rules configured in LwM2M EDGEAPP Gateway, such as considering the services areas and/or service continuity support.

At step 2109, LwM2M EDGEAPP Gateway initiates the EEC registration procedure towards the selected EES on behalf of LwM2M-based EEC. As described in section 8.4.2 of 3GPPTS 23.558 V17.1.0, the EEC registration procedure is to provide information that can be used by the EES in EAS discovery.

The request may include EEC ID (from endpoint name of LwM2M registration message) and security credentials.

In an embodiment, EEC registration may be triggered by LwM2M registration.

At step 2110, LwM2M EDGEAPP Gateway sends Register/Registration Update response to LwM2M-based EEC.

At step 2111, LwM2M EDGEAPP Gateway decides to discover EAS for example based on a policy.

At step 2112, LwM2M EDGEAPP Gateway initiates the EAS discovery procedure and selects an EAS on behalf of LwM2M-based EEC. As described in section 8.5 of 3GPP TS 23.558 V17.1.0, EAS discovery procedure is to obtain information about EAS so that AC can access the services provided by EAS.

The request may include EEC ID, security credentials, and UE Location. LwM2M EDGEAPP Gateway may retrieve UE location from 3GPP networks.

The response may include EAS list.

In an embodiment, LwM2M EDGEAPP Gateway triggers EAS discovery procedure instead of EEC.

After receiving the response, LwM2M EDGEAPP Gateway further selects an EAS on behalf of LwM2M-based EEC. The selection logic can be based on some predefined rules configured in LwM2M EDGEAPP Gateway, such as considering the services areas, transport support or/and service continuity support.

At step 2113, LwM2M EDGEAPP Gateway sends a request to write the discovered EAS information to the LwM2M-based EEC by creating a new instance of ‘EAS Information’ object and setting the type as ‘source’.

At step 2114, LwM2M-based EEC sends a successful response to LwM2M EDGEAPP Gateway.

At step 2115, LwM2M-based EEC sends EAS information through EDGE-5 to AC.

At step 2116, AC starts application data traffic with the selected EAS and may use constrained protocol (e.g., CoAP or MQTT (Message Queuing Telemetry Transport)).

Some messages of FIG. 21 may be same as the corresponding messages as described in 3GPP TS 23.558 V17.1.0 and OMA-TS-LightweightM2M_Core-V1_2-20201110-A. Some messages of FIG. 21 are enhanced by embodiments of the present disclosure.

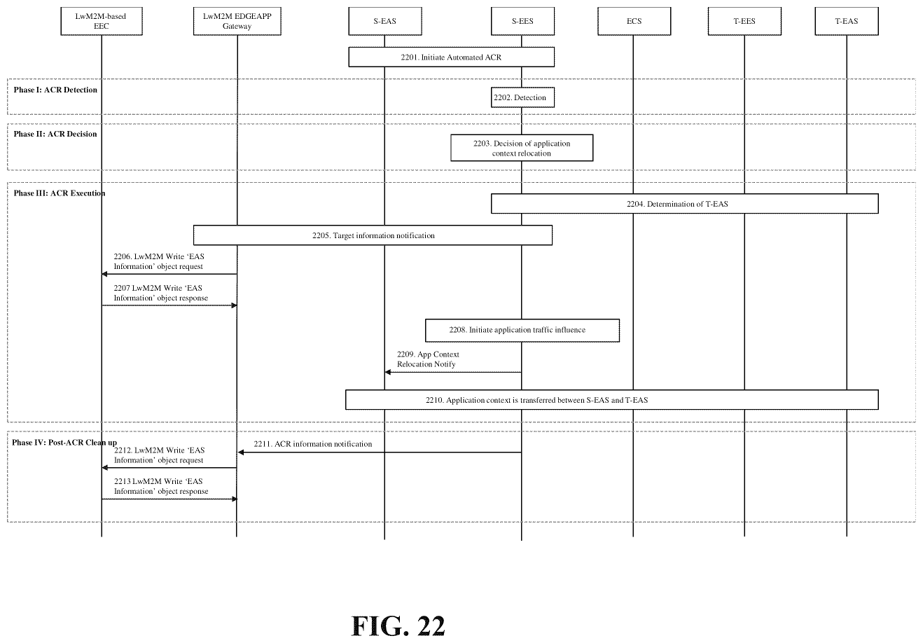

FIG. 22 shows a flowchart of automate ACR procedure according to another embodiment of the present disclosure. This method may be implemented in the architecture of FIG. 20.

When a UE (i.e., terminal device) moves to a new location, different EASs can be more suitable for serving the ACs in the UE. S-EAS may need to transfer the application context to T-EAS. This procedure is call Context Relocation (CR). For constrained devices, automate CR triggered by EES may be more suitable.

At step 2201, the S-EAS initiates Automated ACR with S-EES. In this step, the S-EAS and S-EES negotiate an address of the Application Context storage to S-EES. The S-EAS puts the Application Context at this address which can be further accessed by the S-EES when the ACT (Application Context Transfer) is required.

At step 2202, S-EES detects that ACR may be triggered. The detection may be based on 3GPP Monitoring Events (e.g., location change).

At step 2203, the S-EES decides to execute ACR based on the detection information.

At step 2204, the S-EES determines T-EES and T-EAS via the Discover T-EAS procedure.

At step 2205, the S-EES sends the target information notification to the LwM2M EDGEAPP Gateway.

At step 2206, LwM2M EDGEAPP Gateway uses LwM2M to send a request to write the T-EAS information to LwM2M-based EEC by creating a new instance of ‘EAS Information’ object and setting the type as ‘target’. EAS instance is being marked as ‘target’ which means that this EAS is just regarded as a placeholder but not yet ready to serve AC since the Application Context relocation is not completed.

At step 2207, LwM2M-based EEC sends a successful LwM2M response to LwM2M EDGEAPP Gateway.

At step 2208, the S-EES may optionally influence the AF traffic routing.

At step 2209, the S-EES sends the ACR Notify message to the S-EAS to initiate ACT between the S-EAS and the T-EAS.

At step 2210, the Application Context is transferred from S-EAS to the T-EAS at implementation specific time.

At step 2211, the S-EES sends the ACR information notification message to the EEC to confirm that the ACR has completed.

At step 2212, LwM2M EDGEAPP Gateway uses LwM2M to send a write request to update the type of previously created ‘EAS Information’ object instance as ‘source’. EAS instance is being marked as ‘source which means that this EAS is ready to serve AC since the Application Context relocation has been completed. AC shall switch application data communication from previous EAS to this one.

At step 2213, LwM2M-based EEC sends a successful LwM2M response to LwM2M EDGEAPP Gateway.

In an embodiment, LwM2M EDGEAPP Gateway may delete the ‘EAS Information’ object instance representing S-EAS in LwM2M-based EEC.

Some messages of FIG. 22 may be same as the corresponding messages as described in 3GPP TS 23.558 V17.1.0 and OMA-TS-LightweightM2M_Core-V1_2-20201110-A. Some messages of FIG. 22 are enhanced by embodiments of the present disclosure.

In an embodiment, a new LwM2M object ‘EAS Information’ for representing EAS(s) may be introduced in OMA-TS-LightweightM2M_Core-V1_2-20201110-A. Multiple instances may be created to represent S-EAS and T-EAS, distinguished by attribute ‘Type’. Table 1 shows an example of the new LwM2M object ‘EAS Information’ Object. RW denotes read and write.

TABLE 1
‘EAS Information’ Object

| | | | Opera- | Multi- |
|---|---|---|---|---|
| Item | Type | Mandatory | tions | pleInstances |
| EAS ID | String | Mandatory | RW | Single |
| EAS Endpoint | String | Mandatory | RW | Single |
| AC ID | String | Optional | RW | Single |
| Type | RangeEnumer- | Mandatory | RW | Single |
| | ation<source, | | | |
| | target> | | | |

According to some embodiments of the present disclosure, it introduce a gateway (such as ‘LwM2M EDGEAPP Gateway’ (acting as a LwM2M Server)) to facilitate the communication between LwM2M devices and ECS/EES in EDGEAPP.

According to some embodiments of the present disclosure, it can reuse existing LwM2M operations to enable LwM2M devices to communicate with EAS inside EDN in EDGEAPP.

According to some embodiments of the present disclosure, it introduces new LwM2M data model objects to support edge computing services.

Embodiments herein afford many advantages, of which a non-exhaustive list of examples follows. Some embodiments herein can enable the EDGEAPP support to resource constrained devices such as LwM2M devices. In some embodiments herein, there is no impact to 3GPP EDGEAPP architecture and reference points. Some embodiments herein can enable resource constrained devices such as LwM2M devices to communicate with EAS inside EDN in EDGEAPP by using protocol (such as CoAP) designed for the resource constrained devices. The embodiments herein are not limited to the features and advantages mentioned above. A person skilled in the art will recognize additional features and advantages upon reading the following detailed description.

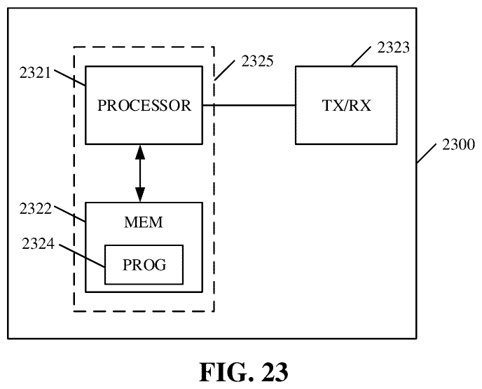

FIG. 23 is a block diagram showing an apparatus suitable for practicing some embodiments of the disclosure. For example, any one of the gateway, the terminal device and the bootstrap server described above may be implemented as or through the apparatus 2300.

The apparatus 2300 comprises at least one processor 2321, such as a digital processor (DP), and at least one memory (MEM) 2322 coupled to the processor 2321. The apparatus 2320 may further comprise a transmitter TX and receiver RX 2323 coupled to the processor 2321. The MEM 2322 stores a program (PROG) 2324. The PROG 2324 may include instructions that, when executed on the associated processor 2321, enable the apparatus 2320 to operate in accordance with the embodiments of the present disclosure. A combination of the at least one processor 2321 and the at least one MEM 2322 may form processing means 2325 adapted to implement various embodiments of the present disclosure.

Various embodiments of the present disclosure may be implemented by computer program executable by one or more of the processor 2321, software, firmware, hardware or in a combination thereof.

The MEM 2322 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 2321 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the gateway, the memory 2322 contains instructions executable by the processor 2321, whereby the gateway operates according to any step of any of the methods related to the gateway as described above.

In an embodiment where the apparatus is implemented as or at the terminal device, the memory 2322 contains instructions executable by the processor 2321, whereby the terminal device operates according to any step of the methods related to the terminal device as described above.

In an embodiment where the apparatus is implemented as or at the bootstrap server, the memory 2322 contains instructions executable by the processor 2321, whereby the bootstrap server operates according to any step of the methods related to the bootstrap server as described above.

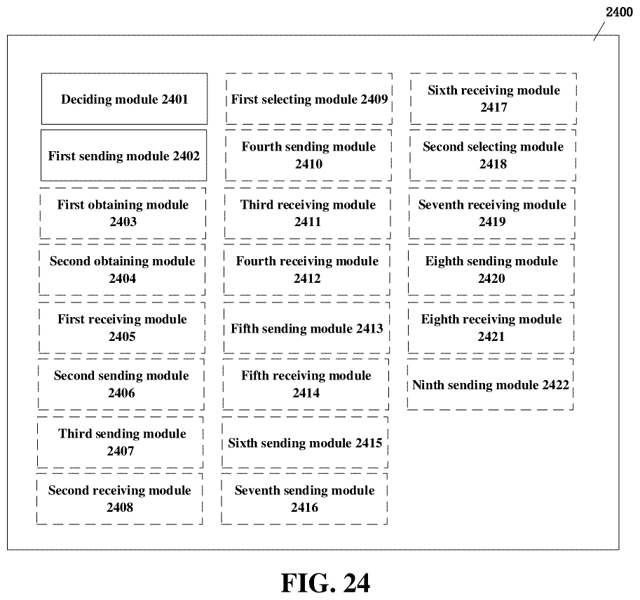

FIG. 24 is a block diagram showing a gateway according to an embodiment of the disclosure. As shown, the gateway 2400 comprises a deciding module 2401 configured to decide to discover a first Edge Application Server (EAS) for a terminal device. The gateway 2400 further comprises a first sending module 2402 configured to send a first message comprising information about the first EAS to the terminal device.

In an embodiment, the gateway 2400 further comprises a first obtaining module 2403 configured to obtain Edge Configuration Server (ECS) configuration information.

In an embodiment, the gateway 2400 further comprises a second obtaining module 2404 configured to obtain an identifier of an Edge Enabler Client (EEC) and at least one application client (AC) profile of at least one AC in the terminal device.

In an embodiment, the gateway 2400 further comprises a first receiving module 2405 configured to receive a registration request comprising an identifier of an Edge Enabler Client (EEC) from the terminal device.

In an embodiment, the gateway 2400 further comprises a second sending module 2406 configured to send a response for the registration request to the terminal device.

In an embodiment, the gateway 2400 further comprises a third sending module 2407 configured to send a second message comprising the identifier of EEC and security credentials to an Edge Configuration Server (ECS).

In an embodiment, the gateway 2400 further comprises a second receiving module 2408 configured to receiving a third message comprising one or more Edge Data Network (EDN) configuration information from the ECS. Each EDN configuration information comprises information about one or more Edge Enabler Servers (EES).

In an embodiment, the gateway 2400 further comprises a first selecting module 2409 configured to select an EES from the one or more EES.

In an embodiment, the gateway 2400 further comprises a fourth sending module 2410 configured to sending an EEC registration request comprising the identifier of EEC and security credentials to the selected EES.

In an embodiment, the gateway 2400 further comprises a third receiving module 2411 configured to receive an EEC registration response from the selected EES.

In an embodiment the gateway 2400 further comprises a fourth receiving module 2412 configured to receive a registration update request comprising updated registration information from the terminal device.

In an embodiment, the gateway 2400 further comprises a fifth sending module 2413 configured to send an EEC registration update request comprising the updated registration information to the selected EES.

In an embodiment, the gateway 2400 further comprises a fifth receiving module 2414 configured to receive an EEC registration update response from the selected EES.

In an embodiment, the gateway 2400 further comprises a sixth sending module 2415 configured to sending a registration update response to the terminal device.

In an embodiment, the gateway 2400 further comprises a seventh sending module 2416 configured to sending an EAS discovery request to the selected EES. The EAS discovery request comprises the identifier of EEC and security credentials.

In an embodiment, the gateway 2400 further comprises a sixth receiving module 2417 configured to receive an EAS discovery response from the selected EES. The EAS discovery response comprises information about one or more discovered EASs.

In an embodiment, the gateway 2400 further comprises a second selecting module 2418 configured to select the first EAS from the one or more discovered EASs.

In an embodiment, the gateway 2400 further comprises a seventh receiving module 2419 configured to receive target information notification from the selected EES. The target information notification comprises information about a second EAS.

In an embodiment, the gateway 2400 further comprises an eighth sending module 2420 configured to send the target information notification to the terminal device.

In an embodiment, the gateway 2400 further comprises an eighth receiving module 2421 configured to receive from the selected EES a second message for confirming that Application Context Relocation (ACR) has completed.

In an embodiment, the gateway 2400 further comprises a ninth sending module 2422 configured to send to the terminal device a third message for indicating that an application client in the terminal device can switch application data communication from the first EAS to the second EAS.

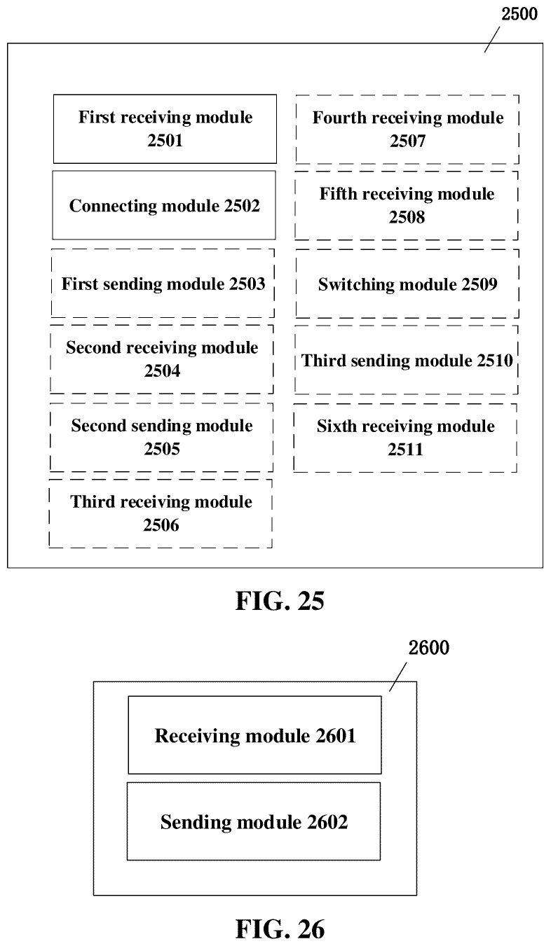

FIG. 25 is a block diagram showing a terminal device according to an embodiment of the disclosure. As shown, the terminal device 2500 comprises a first receiving module 2501 configured to receive a first message comprising information about a first Edge Application Server (EAS) from a gateway. The terminal device 2500 further comprises a connecting module 2502 configured to connect to the first EAS.

In an embodiment, the terminal device 2500 further comprises a first sending module 2503 configured to send a registration request comprising an identifier of an Edge Enabler Client (EEC) to the gateway.

In an embodiment, the terminal device 2500 further comprises a second receiving module 2504 configured to receiving a response for the registration request from the gateway.

In an embodiment, the terminal device 2500 further comprises a second sending module 2505 configured to send a registration update request comprising updated registration information to the gateway.

In an embodiment, the terminal device 2500 further comprises a third receiving module 2506 configured to receive a registration update response from the gateway.

In an embodiment, the terminal device 2500 further comprises a fourth receiving module 2507 configured to receive target information notification from the gateway. The target information notification comprises information about a second EAS.

In an embodiment, the terminal device 2500 further comprises a fifth receiving module 2508 configured to receive from the gateway a third message for indicating that an application client in the terminal device can switch application data communication from the first EAS to the second EAS.

In an embodiment, the terminal device 2500 further comprises a switching module 2509 configured to switch application data communication from the first EAS to the second EAS.

In an embodiment, the terminal device 2500 further comprises a third sending module 2510 configured to send a bootstrap request to a bootstrap server.

In an embodiment, the terminal device 2500 further comprises a sixth receiving module 2511 configured to receive from the bootstrap server a bootstrap write request to configure the terminal device with information about the gateway.

FIG. 26 is a block diagram showing a bootstrap server according to an embodiment of the disclosure. As shown, the bootstrap server 2600 comprises a receiving module 2601 configured to receive a bootstrap request from a terminal device. The bootstrap server 2600 further comprises a sending module 2602 configured to send to the terminal device a bootstrap write request to configure the terminal device with information about the gateway.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the gateway, the terminal device or the bootstrap server may not need a fixed processor or memory, any computing resource and storage resource may be arranged from the gateway, the terminal device or the bootstrap server in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-54. (canceled)

55. A method performed by a gateway, comprising:
deciding to discover a first Edge Application Server (EAS) for a terminal device; and
sending a first message comprising information about the first EAS to the terminal device;
wherein the information about the first EAS comprises at least one of:
an identifier of the first EAS,
endpoint information of the first EAS, or
an identity of an application client (AC).

56. The method according to claim 55, wherein the first message comprises at least one of:
a response for a registration request from the terminal device, or
a write request.

57. The method according to claim 55, wherein the information about the first EAS further comprises a type of the first EAS and the type of the first EAS is set as source.

58. The method according to claim 55, further comprising:
receiving a registration request comprising an identifier of an Edge Enabler Client (EEC) from the terminal device; and
sending a response for the registration request to the terminal device.

59. The method according to claim 58, further comprising:
sending a second message comprising the identifier of EEC and security credentials to an Edge Configuration Server (ECS);
receiving a third message comprising one or more Edge Data Network (EDN) configuration information from the ECS, wherein each EDN configuration information comprises information about one or more Edge Enabler Servers (EES); and
selecting an EES from the one or more EES.

60. The method according to claim 59, further comprising:
receiving target information notification from the selected EES, wherein the target information notification comprises information about a second EAS; and
sending the target information notification to the terminal device; and/or
wherein the target information notification is sent to the terminal device in a write request for writing the information about the second EAS to the terminal device; and/or
wherein the information about the second EAS comprises at least one of:
an identifier of the second EAS,
endpoint information of the second EAS, or
an identity of an application client (AC).

61. The method according to claim 60, wherein the information about the second EAS further comprises a type of the second EAS and the type of the second EAS is set as target; and/or
wherein the target information notification indicates that the second EAS is not ready to serve an application client in the terminal device.

62. The method according to claim 60, further comprising:
receiving from the selected EES a second message for confirming that Application Context Relocation (ACR) has completed; and
sending to the terminal device a third message for indicating that an application client in the terminal device can switch application data communication from the first EAS to the second EAS; and/or
wherein the third message is a write request for updating a type of the second EAS as source.

63. The method according to claim 55, wherein the terminal device comprises at least one of:
a resource constrained device,
an Internet of thing device, or
a lightweight machine to machine (LwM2M) client.

64. The method according to claim 55, wherein a communication between the terminal device and the gateway uses at least one of:
Internet of Thing (IoT) protocol,
LwM2M Protocol, or
Constrained Application Protocol (CoAP).

65. A method performed by a terminal device, comprising:
receiving a first message comprising information about a first Edge Application Server (EAS) from a gateway; and
connecting to the first EAS;
wherein the information about the first EAS comprises at least one of:
an identifier of the first EAS,
endpoint information of the first EAS, and
an identity of an application client (AC).

66. The method according to claim 65, wherein the first message comprises at least one of:
a response for a registration request from the terminal device, or
a write request.

67. The method according to claim 65, wherein the information about the first EAS further comprises a type of the first EAS and the type of the first EAS is set as source.

68. The method according to claim 65, further comprising:
receiving target information notification from the gateway, wherein the target information notification comprises information about a second EAS; and/or
wherein the target information notification is received from the gateway in a write request for writing the information about the second EAS to the terminal device; and/or
wherein the information about the second EAS comprises at least one of:
an identifier of the second EAS,
endpoint information of the second EAS, and
an identity of an application client (AC).

69. The method according to claim 68, wherein the information about the second EAS further comprises a type of the second EAS and the type of the second EAS is set as target; and/or
wherein the target information notification indicates that the second EAS is not ready to serve an application client in the terminal device.

70. The method according to claim 68, further comprising:
receiving from the gateway a third message for indicating that an application client in the terminal device can switch application data communication from the first EAS to the second EAS; and
switching application data communication from the first EAS to the second EAS; and/or
wherein the third message is a write request for updating a type of the second EAS as source.

71. The method according to claim 65, further comprising:
sending a bootstrap request to a bootstrap server; and
receiving from the bootstrap server a bootstrap write request to configure the terminal device with information about the gateway.

72. The method according to claim 65, wherein the terminal device comprises at least one of:
a resource constrained device,
an Internet of thing device, or
a lightweight machine to machine (LwM2M) client.

73. The method according to claim 65, wherein a communication between the terminal device and the gateway and a communication between the terminal device and a bootstrap server use at least one of:
Internet of Thing (IoT) protocol,
LwM2M Protocol, or
Constrained Application Protocol (CoAP).

74. A terminal device, comprising:
a processor; and
a memory coupled to the processor, said memory containing instructions executable by said processor, whereby said terminal device is operative to:
receive a first message comprising information about a first Edge Application Server (EAS) from a gateway; and
connect to the first EAS;
wherein the information about the first EAS comprises at least one of:
an identifier of the first EAS,
endpoint information of the first EAS, and
an identity of an application client (AC).
